(19) United States
(12) Patent Application Publication
(10) Pub. No.: US 2026/0074107 A1
(43) Pub. Date: Mar. 12, 2026

(54) INDUCTOR WITH FUNCTIONAL PINS CLOSE TO EACH OTHER

(71) Applicant: ITG ELECTRONICS, INC., Elmsford, NY (US)

(72) Inventors: Martin KUO, Elmsford, NY (US); Nanhai ZHU, Elmsford, NY (US)

(73) Assignee: ITG ELECTRONICS, INC., Elmsford, NY (US)

(21) Appl. No.: 18/883,437

(22) Filed: Sep. 12, 2024

(51) Int. Cl. H01F 27/29; H01F 27/26; H01F 27/28

(52) U.S. Cl. CPC H01F 27/29; H01F 27/263; H01F 27/2847; H01F 2027/297

(57) ABSTRACT

An inductor with function pins close to each other is provided. The inductor with function pins close to each other includes an upper iron core, a lower iron core and a coil. One end of a first side wall corresponds to one end of a second side wall and is connected with a fixing pillar, another end of the first side wall extends away from the fixing pillar to form a first functional pin, another end of the second side wall extends away from the fixing pillar to form a second functional pin. The first side wall is disposed in a first accommodation space of the upper iron core and a first accommodation space of the lower iron core, the second side wall is disposed in a second accommodation space of the upper iron core and a second accommodation space of the lower iron core.

### FIELD OF THE DISCLOSURE

The present disclosure relates to the field of inductors, and in particular, to an inductor with functional pins close to each other.

### BACKGROUND OF THE DISCLOSURE

The pins of conventional inductors may be formed on opposite sides of the inductor, or at four diagonal corners of the inductor. As a result, it needs a long path for signal transmission, causing a longer transmission time, thereby increasing difficulty in circuit layout. Therefore, how to shorten the signal transmission path and reduce the time required for signal transmission is the trend in the field of inductors development these days.

### SUMMARY OF THE DISCLOSURE

In response to the above-referenced technical inadequacies, the present disclosure provides an inductor with functional pins close to each other, which may improve the deficiencies of existing technologies. The advantages of the present disclosure are described below. Firstly, two functional pins are formed on the same side of the inductor, and the distance between the two functional pins may be controlled, so that the two functional pins may be arranged relatively close to each other, effectively shortening the signal transmission path. Secondly, the inductor with functional pins close to each other has a fixing pillar arranged on the other side relative to the two functional pins. The two functional pins and the fixing pillar may elevate the inductor to form a space between the inductor and the circuit board. The space may be used to accommodate other electronic components or equipment and increase bottom utilization.

To solve the above problem, the present disclosure provides an inductor with functional pins close to each other, which includes an upper iron core, a lower iron core, and a coil. The upper iron core has a first accommodation space of the upper iron core and a second accommodation space of the upper iron core. The lower iron core has a first accommodation space of the lower iron core and a second accommodation space of the lower iron core. The first accommodation space of the upper iron core corresponds to the first accommodation space of the lower iron core, and the second accommodation space of the upper iron core corresponds to the second accommodation space of the lower iron core. The coil has a first side wall, a second side wall and a fixing pillar. The first side wall and the second side wall are equal in size and parallel to each other. One end of the first side wall corresponds to one end of the second side wall and the one end of the first side wall is connected to the one end of the second side wall through fixing pillar, and another end of the first side wall extends in a direction away from the fixing pillar to form a first functional pin, and another end of the second side wall extends in the direction away from the fixing pillar to form a second functional pin. The first functional pin and the second functional pin are formed on a same side of the inductor with functional pins close to each other, the first functional pin and the fixing pillar are formed on different sides of the inductor with functional pins close to each other, and the second functional pin and the fixing pillar are formed on different sides of the inductor with functional pins close to each other. One part of the first side wall is arranged in the first accommodation space of the upper iron core, and another part of the first side wall is arranged in the first accommodation space of the lower iron core. One part of the second side wall is disposed in the second accommodation space of the upper iron core, and another part of the second side wall is disposed in the second accommodation space of the lower iron core. The upper iron core is engaged to the lower iron core, and the upper iron core, the coil and the lower iron core are configured to combined.

Optionally, the first side wall, the second side wall and the fixing pillar of the coil jointly define a U-shaped coil groove.

Optionally, the first functional pin extends along a direction perpendicular to the first side wall, and the second functional pin extends along a direction perpendicular to the second side wall, and the first functional pin and the second functional pin extend in a direction away from each other.

Optionally, the fixing pillar is formed on an opposite side of the inductor with functional pins close to each other relative to the first functional pin and the second functional pin.

Optionally, each of a height of the first functional pin, a height of the second functional pin and a height of the fixing pillar is greater than or equal to a height of the first side wall, and each of the height of the first functional pin, the height of the second functional pin and the height of the fixing pillar is greater than or equal to a height of the second side wall.

Optionally, the upper iron core has an upper iron core central pillar and two upper iron core side pillars, and the lower iron core has a lower iron core central pillar and two lower iron core side pillars.

Optionally, the upper iron core central pillar and one of the two upper iron core side pillars define the first accommodation space of the upper iron core, and the upper iron core center pillar and another one of the two upper iron core side pillars define the second accommodation space of the upper iron core; the lower core center pillar and one of the two lower core side pillars define the first accommodation space of the lower core, and the lower core center pillar and another one of the two lower core side pillars define the second accommodation space of the lower core.

Optionally, the two upper iron core side pillars are respectively abutted against the two lower iron core side pillars, and the upper iron core central pillar and the lower iron core central pillar are abutted against each other and are arranged in the U-shaped coil groove.

Optionally, each of the upper iron core and the lower iron core is a M-shaped iron core or an E-shaped iron core.

Optionally, the coil is made of copper sheets or conductive materials by stamping or bending process, and the coil is an integrally formed structure.

Optionally, the lower iron core has a bottom surface, and the bottom surface, the first functional pin, the second functional pin and the fixing pillar jointly define a space.

Optionally, the first functional pin and the second functional pin are pins configured to be inserted into a circuit board.

One of the beneficial effects of the present disclosure is that, in the inductor with functional pins close to each other provided by the present disclosure, by virtue of “two functional pins are formed on the same side of the inductor, and the two functional pins may be arranged relatively close to each other depending on particular implementations” so that the signal transmission path may be effectively shorten and the time required to transmit signals may be reduced. Another beneficial effect is that, through the technical solution of “with the fixing pillar arranged on the other side relative to the two functional pins, the two functional pins and the fixing pillar may elevate the inductor to form a space between the inductor and the circuit board”, the space may be used to accommodate other electronic parts or equipment, thereby increasing the utilization of the bottom of the overall inductor.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic exploded diagram of a inductor with functional pins close to each other according to a first embodiment of the present disclosure;

FIG. 2 is a schematic assembled diagram of the inductor with functional pins close to each other according to the first embodiment of the present disclosure;

FIG. 3 is a schematic cross-sectional view taken along line III-III of FIG. 2;

FIG. 4 is a schematic diagram of coils of the inductor with functional pins close to each other of the present disclosure;

FIG. 5 is a schematic exploded diagram of an inductor with functional pins close to each other according to a second embodiment of the present disclosure;

FIG. 6 is a schematic exploded diagram of an inductor with functional pins close to each other according to a third embodiment of the present disclosure; and

FIG. 7 is a schematic exploded diagram of an inductor with functional pins close to each other according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

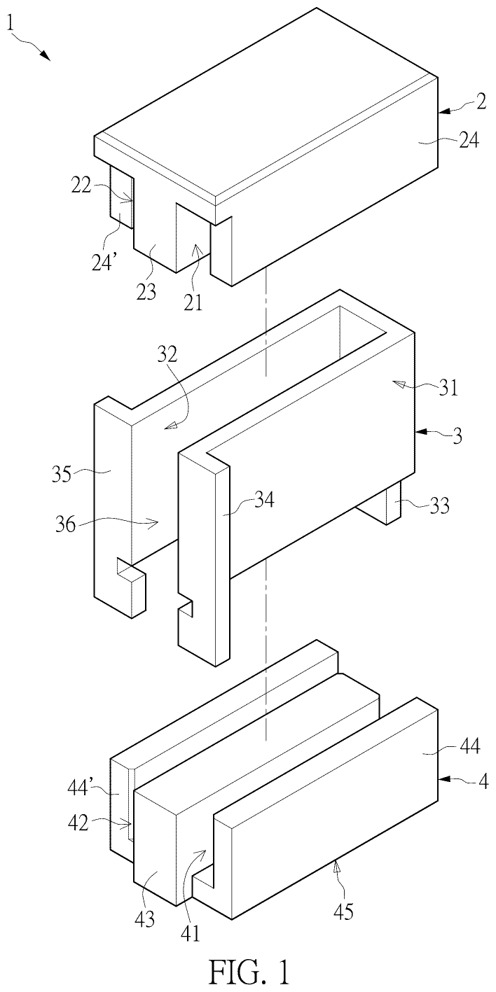

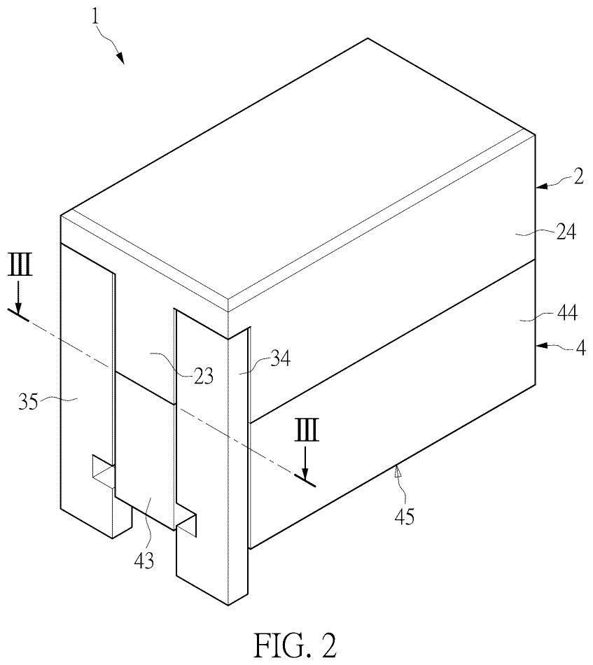

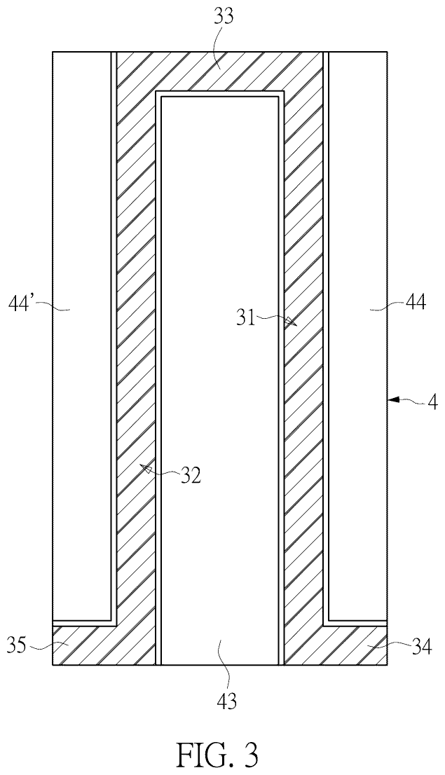

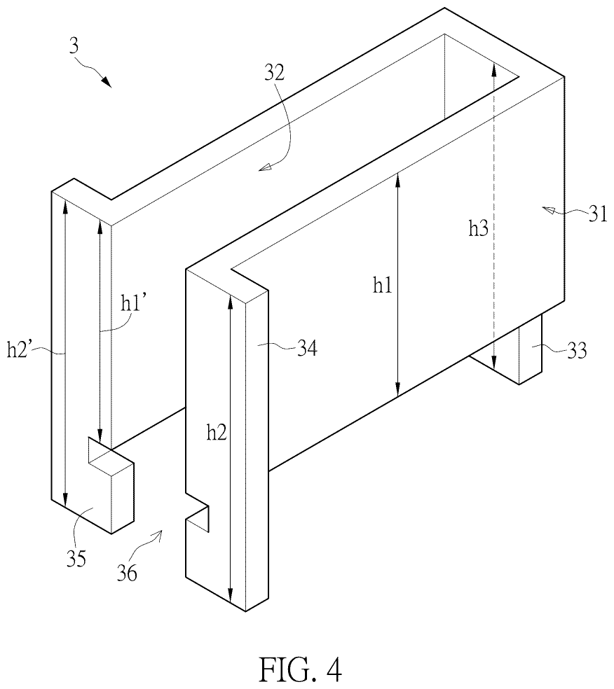

Referring to FIG. 1 to FIG. 4, FIG. 1 is a schematic exploded diagram of an inductor with functional pins close to each other according to a first embodiment of the present disclosure; FIG. 2 is a schematic assembled diagram of the inductor with functional pins close to each other according to the first embodiment of the present disclosure; FIG. 3 is a schematic cross-sectional view taken along line III-III of FIG. 2; and FIG. 4 is a schematic diagram of coils of the inductor with functional pins close to each other of the present disclosure. As shown in FIG. 1, an inductor with functional pins close to each other 1 includes an upper iron core 2, a coil 3 and a lower iron core 4. The upper iron core 2 has a first accommodation space of the upper iron core 21 and a second accommodation space of the upper iron core 22. The lower iron core 4 has a first accommodation space of the lower iron core 41 and a second accommodation space of the lower iron core 42. The first accommodation space of the upper iron core 21 corresponds to the first accommodation space of the lower iron core 41, and the second accommodation space of the upper iron core 22 corresponds to the second accommodation space of the lower iron core 42. The coil 3 has a first side wall 31, a second side wall 32 and a fixing pillar 33. The first side wall 31 and the second side wall 32 are equal in size and parallel to each other. One end of the first side wall 31 corresponds to one end of the second side wall 32 and the one end of the first side wall 31 is connected to the one end of the second side wall through the fixing pillar 33, and another end of the first side wall 31 extends in a direction away from the fixing pillar 33 to form a first functional pin 34, and another end of the second side wall 32 extends in the direction away from the fixing pillar 33 to form a second functional pin 35. The first functional pin 34 and the second functional pin 35 are formed on the same side of the inductor with functional pins close to each other 1, the first functional pin 34 and the fixing pillar 33 are formed on different sides of the inductor with functional pins close to each other 1, and the second functional pin 35 and the fixing pillar are formed on different sides of the inductor with functional pins close to each other 1 relative to the fixing pillar 33. Depends on particular implementations, each of the upper iron core 2 and the lower iron core 4 may be an E-shaped iron core or a M-shaped cores, and their materials may be, but are not limited to, ferrite or other soft magnetic materials.

Further, the first side wall 31, the second side wall 32 and the fixing pillar 33 of the coil jointly define a U-shaped coil groove 36.

Further, as shown in FIG. 4, another end of the first side wall 31 of the coil 3 is bent perpendicular to a direction of the first side wall 31 and extended to form a first functional pin 34, and another end of the second side wall 32 of the coil 3 is bent perpendicular to a direction of the second side wall 32. That is, the first functional pin 34 extends perpendicularly to the first side wall 31, the second functional pin 35 extends perpendicularly to the second side wall 32. The first functional pin 34 and the second functional pin 35 may extend in a direction away from each other, may extend in a direction facing each other, or may extend in different directions respectively. The present disclosure does not limit the extending directions of the first functional pins 34 and the second functional pins 35.

The fixing pillar 33 is formed on an opposite side of the inductor with functional pins close to each other 1 relative to the first functional pin 34 and the second functional pin 35 to support the inductor with functional pins close to each other 1 and stably fix the inductor with functional pins close to each other 1 on a circuit board.

Preferably, the first functional pin 34 and the second functional pin 35 may be very close to each other.

In the first embodiment of the present disclosure, as shown in FIG. 4, the first side wall 31 has a height h1, the second side wall 32 has a height h1′. The first functional pin 34 has a height h2, and the second functional pin 35 has a height h2′. The fixing pillar 33 has a height h3.

The height h1 of the first side wall 31 is similar to the height h1′ of the second side wall 32; the height h2 of the first functional pin 34, the height h2′ of the second functional pin 35 and the height h3 of the fixed pillar 33 are similar to each other. It should be note that the heights h1, h1′, h2, h2′ and h3 may be different. For example, the height h1 of the first side wall 31 may be greater than the height h1′ of the second side wall 32; the height h2 of the functional pin 34 and the height h2′ of the second functional pin 35 may be greater than the height h3 of the fixed pillar 33; the height h2 of the first functional pin 34 may also be greater than the height h2′ of the second functional pin 35 and the height h3 of the fixed pillar 33.

Preferably, the height h2 of the first functional pin 34, the height h2′ of the second functional pin 35, and the height h3 of the fixing pillar 33 may be greater than or equal to the height h1 of the first side wall 31, and the height h2 of the first functional pin 34, the height h2′ of the second functional pin 35, and the height h3 of the fixing pillar 33 may be greater than or equal to the height h1′ of the second side wall 32, so that the first functional pin 34, the second functional pin 35 and the fixing pillar 33 may elevate the inductor with functional pins close to each other 1. Optionally, the first functional pin 34, the second functional pin 35 and the fixing pillar 33 do not elevate the inductor with functional pins close to each other 1. Accordingly, the heights h1, h1′, h2, h2′ and h3 and the functions may be respectively adjusted according to the user's needs or particular implementations.

Preferably, the coil 3 is made of copper sheets or conductive materials by stamping process or bending process, and is an integrally formed structure.

As shown in FIG. 1, the upper iron core 2 has an upper iron core center pillar 23 and two upper core side pillars 24, 24′, and the lower iron core 4 has a lower iron core center pillar 43 and two lower iron core side pillars 44, 44′. The upper iron core center pillar 23 and the upper iron core side pillar 24 form the first accommodation space of the upper iron core 21. The upper iron core center pillar 23 and the upper iron core side pillar 24′ form the second accommodation space of the lower iron core 22. The lower iron core center pillar 43 and the lower iron core side pillar 44 form the first accommodation space of the lower iron core 41, and the lower iron core center pillar 43 and the lower iron core side pillar 44′ form the second accommodation space of the lower iron core 42.

The assembly method of the inductor with functional pins close to each other 1 in the first embodiment of the present disclosure is described as follows:
One part of the first side wall 31 is arranged in the first accommodation space of the upper iron core 21, and another part of the first side wall 31 is arranged in the first accommodation space of the lower iron core 41. One part of the second side wall 32 is disposed in the second accommodation space of the upper iron core 22, and another part of the second side wall 32 is disposed in the second accommodation space of the lower iron core 42.

As shown in FIGS. 2 and 3, the first side wall 31, the second side wall 32 of the coil 3 and the fixed column 33 jointly define a U-shaped coil groove 36. The two upper iron core side pillars 24, 24′ and the two lower iron core side pillars 44, 44′ are respectively abutting against each other. The upper iron core center pillar 23 and the lower iron core center pillar 43 are abutting against each other and are arranged in the U-shaped coil groove 36, so that the upper iron core 2 is engaged to the lower iron core 4.

During assembly, the first functional pin 34 abuts against the upper iron core side pillar 24, the upper iron core center pillar 23, the lower iron core side pillar 44, and the lower iron core center pillar 43. The second functional pin 35 abuts against the upper iron core side pillars 24′, the upper iron core center pillar 23, the lower iron core side pillar 44′, and the lower iron core center pillar 43.

Preferably, the distance between the first functional pin 34 and the second functional pin 35 is controllable, and the first functional pin 34 and the second functional pin 35 may be further arranged relatively close to each other depending on particular implementations for facilitating the rapid transmission of signals.

Preferably, the first functional pin 34 and the second functional pin 35 may be two pins inserted into the slot of the circuit board.

Preferably, the lower iron core 4 has a bottom surface 45, and the bottom surface 45, the first functional pin 34, the second functional pin 35 and the fixing column 33 may jointly define a space. The space may increase the utilization of the bottom of the inductor and may be used to accommodate chips, capacitor ICs or components used on the circuit board.

### Second Embodiment

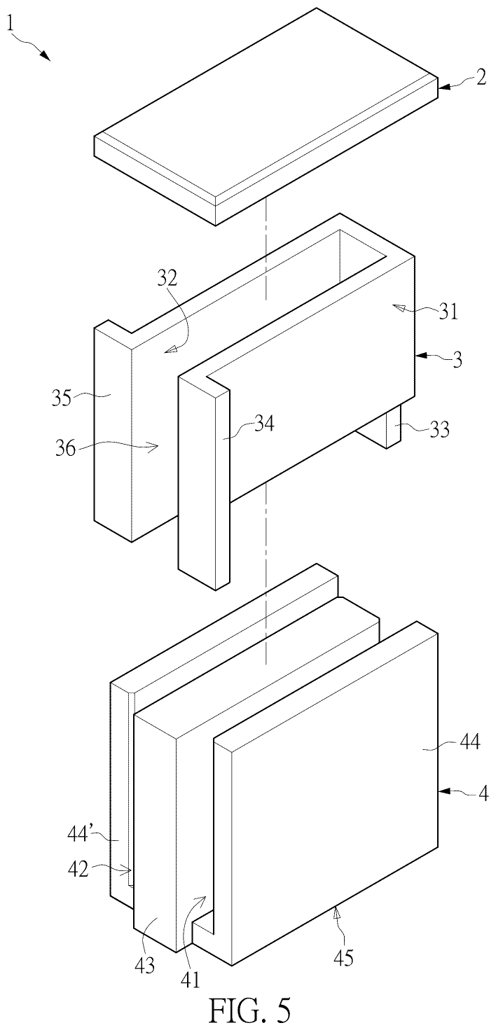

FIG. 5 is a schematic exploded diagram of an inductor with functional pins close to each other 1 according to a second embodiment of the present disclosure. As shown in FIG. 5, the inductor with functional pins close to each other 1 according to a second embodiment of the present disclosure includes an upper iron core 2, a coil 3, and a lower iron core 4. The inductor with functional pins close to each other 1 according to the second embodiment is substantially the same as that according to the first embodiment. The difference between the inductor with functional pins close to each other 1 according to the second embodiment and that according to the first embodiment is that, the upper iron core 2 of the inductor with functional pins close to each other 1 according to the second embodiment of the present disclosure is only a quadrangular flat plate, and the upper iron core 2 does not have any accommodation space or iron core pillars. The lower iron core 4 has a first accommodation space of the lower iron core 41 and a second accommodation space of the lower iron core 42. It should be noted that, when the inductor with functional pins close to each other 1 according to the second embodiment of the present disclosure is assembled, the lower iron core center pillar 43 is arranged in the U-shaped coil groove 36. The lower iron core center pillar 43 and the two lower iron core side pillars 44, 44′ correspondingly abut against the upper iron core 2.

### Third Embodiment

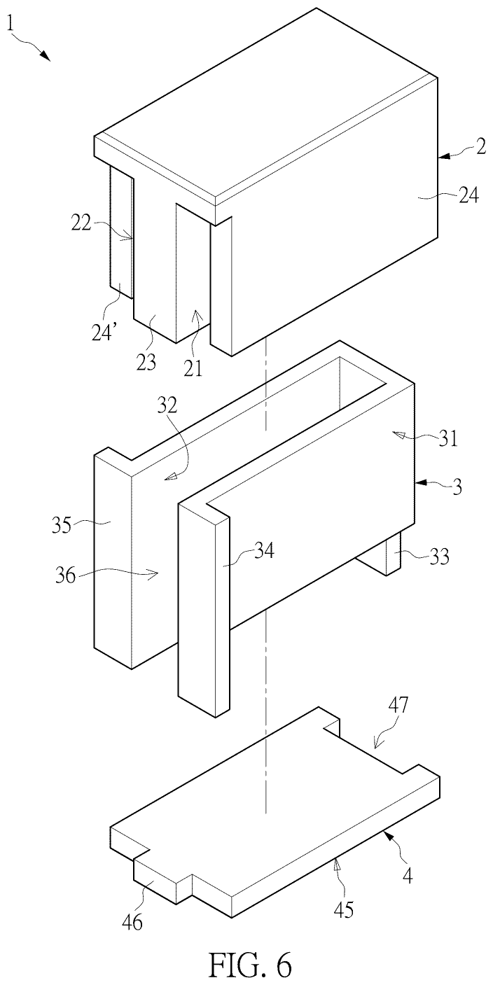

FIG. 6 is a schematic exploded diagram of an inductor with functional pins close to each other 1 according to a third embodiment of the present disclosure. The inductor with functional pins close to each other 1 according to the third embodiment is substantially the same as that according to the first embodiment. The difference between the inductor with functional pins close to each other 1 according to the third embodiment and that according to the first embodiment is that, the lower iron core 4 of the inductor with functional pins close to each other 1 according to the third embodiment is only a flat plate. The lower iron core 4 has a convex portion 46 and a recess portion 47. The lower iron core 4 does not have any accommodation spaces and iron core pillars. It should be noted that, when the inductor with functional pins close to each other 1 according to the third embodiment of the present disclosure is assembled, the upper iron core center pillar 23 is arranged in the U-shaped coil groove 36. The upper iron core center pillar 23 and the two upper iron core side pillars 24, 24′ correspondingly abut against the lower iron core 2.

Further, the upper iron core center pillar 23 abuts the convex portion 46 of the lower iron core 4, and the fixing pillar 33 of the coil 3 is disposed in the recess portion 47.

### Fourth Embodiment

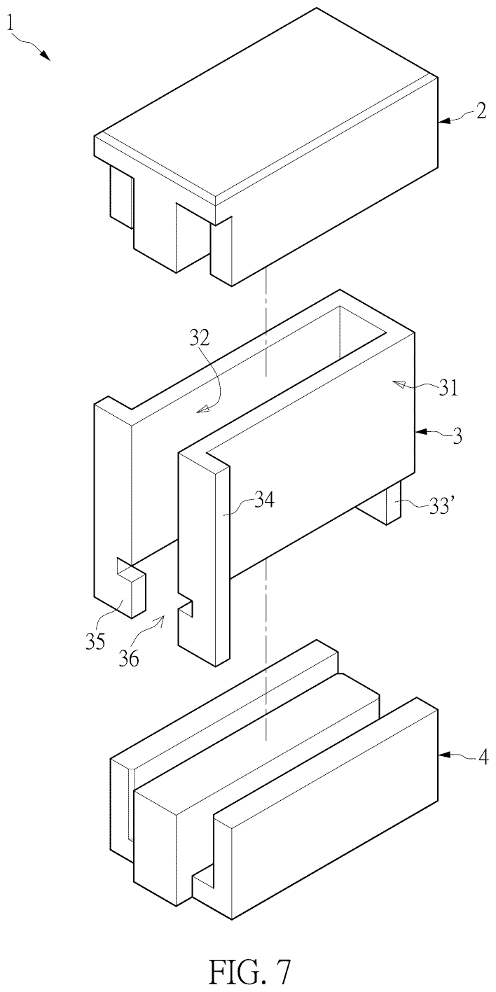

FIG. 7 is a schematic exploded diagram of an inductor with functional pins close to each other according to a fourth embodiment of the present disclosure. The inductor with functional pins close to each other 1 according to the fourth embodiment is substantially the same as that according to the first embodiment. The difference between the inductor with functional pins close to each other 1 according to the fourth embodiment and that according to the first embodiment is that, the fixing pillar 33 of the inductor with functional pins close to each other 1 according to the fourth embodiment may be a third functional pin 33′ similar to the first functional pin 34 and the second functional pin 35, and may be used to transmit signals. Specifically, the inductor with functional pins close to each other 1 according to the fourth embodiment may have three functional pins.

The inductor with functional pins close to each other 1 according to the fourth embodiment is assembled in the same manner as the inductor with functional pins close to each other 1 according to the first embodiment, and will not be described again.

As shown in FIG. 7, the third functional pin 33′ is formed on an opposite side of the inductor with functional pins close to each other 1 relative to the first functional pin 34 and the second functional pin 35. By virtue of the third functional pin 33′, not only the inductor with functional pins close to each other 1 may be supported and stably fixed on the circuit board, but also signals may be transmitted. Specifically, the signal may be transmitted from the first functional pin 34 to the second functional pin 35 or from the second functional pin 35 to the first functional pin 34; the signal may also be transmitted from the first functional pin 34 to the third function pin 33′ or from the second function pin 35 to the third function pin 33′; the signal may further be transmitted from the third function pin 33′ to the first function pin 34 or from the third function pin 33′ to the second function pin 35. The way of signal transmission may be adjusted according to user needs or particular implementations, thus making the inductor more usable.

Preferably, the first functional pin, the second functional pin and the third function pin 33′ may be pins configured to be inserted into a circuit board.

### Beneficial Effects of the Embodiments

One of the beneficial effects of the present disclosure is that, in the inductor with functional pins close to each other provided by the present disclosure, by virtue of “two functional pins are formed on the same side of the inductor, and the two functional pins may be arranged relatively close to each other depending on particular implementations” so that the signal transmission path may be effectively shorten and the time required to transmit signals may be reduced. Another beneficial effect is that, through the technical solution of “with the fixing pillar arranged on the other side relative to the two functional pins, the two functional pins and the fixing pillar may elevate the inductor to form a space between the inductor and the circuit board”, the space may be used to accommodate other electronic parts or equipment, thereby increasing the utilization of the bottom of the overall inductor.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An inductor with functional pins close to each other, comprising:
an upper iron core having a first accommodation space of the upper iron core and a second accommodation space of the upper iron core;
a lower iron core having a first accommodation space of the lower iron core and a second accommodation space of the upper iron core, the first accommodation space of the upper iron core corresponding to the first accommodation space of the lower iron core, and the second accommodation space of the upper iron core corresponding to the second accommodation space of the lower iron core; and
a coil having a first side wall, a second side wall and a fixing pillar, the first side wall and the second side wall being equal in size and being parallel to each other;
wherein one end of the first side wall corresponds to one end of the second side wall and the one end of the first side wall is connected to the one end of the second side wall through the fixing pillar, and another end of the first side wall extends in a direction away from the fixing pillar to form a first functional pin, and another end of the second side wall extends in the direction away from the fixing pillar to form a second functional pin. The first functional pin and the second functional pin are formed on a same side of the inductor with functional pins close to each other, the first functional pin and the fixing pillar are formed on different sides of the inductor with functional pins close to each other, and the second functional pin and the fixing pillar are formed on different sides of the inductor with functional pins close to each other,
wherein one part of the first side wall is arranged in the first accommodation space of the upper iron core, and another part of the first side wall is arranged in the first accommodation space of the lower iron core; one part of the second side wall is disposed in the second accommodation space of the upper iron core, and another part of the second side wall is disposed in the second accommodation space of the lower iron core,
wherein the upper iron core is engaged to the lower iron core, and the upper iron core, the coil and the lower iron core are configured to combined.

2. The inductor with functional pins close to each other according to claim 1, wherein the first side wall, the second side wall and the fixing pillar of the coil jointly define a U-shaped coil groove.

3. The inductor with functional pins close to each other according to claim 1, wherein the first functional pin extends along a direction perpendicular to the first side wall, and the second functional pin extends along a direction perpendicular to the second side wall,
wherein the first functional pin and the second functional pin extend in a direction away from each other.

4. The inductor with functional pins close to each other according to claim 1, wherein the fixing pillar is formed on an opposite side of the inductor with functional pins close to each other relative to the first functional pin and the second functional pin.

5. The inductor with functional pins close to each other according to claim 1, wherein each of a height of the first functional pin, a height of the second functional pin and a height of the fixing pillar is greater than or equal to a height of the first side wall, and each of the height of the first functional pin, the height of the second functional pin and the height of the fixing pillar is greater than or equal to a height of the second side wall.

6. The inductor with functional pins close to each other according to claim 2, wherein the upper iron core has an upper iron core central pillar and two upper iron core side pillars, and the lower iron core has a lower iron core central pillar and two lower iron core side pillars.

7. The inductor with functional pins close to each other according to claim 6, wherein the upper iron core central pillar and one of the two upper iron core side pillars define the first accommodation space of the upper iron core, and the upper iron core center pillar and another one of the two upper iron core side pillars define the second accommodation space of the upper iron core; the lower core center pillar and one of the two lower core side pillars define the first accommodation space of the lower core, and the lower core center pillar and another one of the two lower core side pillars define the second accommodation space of the lower core.

8. The inductor with functional pins close to each other according to claim 7, wherein the two upper iron core side pillars are respectively abutted against the two lower iron core side pillars, and the upper iron core central pillar and the lower iron core central pillar are abutted against each other and are arranged in the U-shaped coil groove.

9. The inductor with functional pins close to each other according to claim 1, wherein each of the upper iron core and the lower iron core is a M-shaped iron core or an E-shaped iron core.

10. The inductor with functional pins close to each other according to claim 1, wherein the coil is made of copper sheets or conductive materials by stamping process or bending process, and the coil is an integrally formed structure.

11. The inductor with functional pins close to each other according to claim 1, wherein the lower iron core has a bottom surface, and the bottom surface, the first functional pin, the second functional pin and the fixing pillar jointly define a space.

12. The inductor with functional pins close to each other according to claim 1, wherein the first functional pin and the second functional pin are pins configured to be inserted into a circuit board.
